(19) United States
(12) Patent Application Publication
(10) Pub. No.: US 2025/0194565 A1
(43) Pub. Date: Jun. 19, 2025

(54) Pet Comfort Station For Dogs

(71) Applicant: Leonard Lewis Osborne, Savannah, GA (US)

(72) Inventor: Leonard Lewis Osborne, Savannah, GA (US)

(21) Appl. No.: 18/981,226

(22) Filed: Dec. 13, 2024

Related U.S. Application Data
(60) Provisional application No. 63/611,587, filed on Dec. 18, 2023.

(51) Int. Cl. A01K 13/00

(52) U.S. Cl. CPC A01K 13/004

(57) ABSTRACT

The Pet Comfort Station for Dogs is a manual self-activated device for dogs. It will comfort, message, and calm the pet dog as it walks through the adjustable comfort rollers on the top and both sides of the device. No other prior art provides the pet dog with the ability to mimic being rubbed on the top and both sides of the dog's body. The invention will allow dogs to soothe themselves while the owner is away from the home for extended periods.

### BACKGROUND OF THE INVENTION

No prior art was discovered relating to a pet comfort station for dogs. Pets are typically left at home by their owners for extended periods of time due to work obligations.

The device would mimic a person rubbing the dog's fur or the top and both sides of the dog's body. The device could also provide a piece of mind for the pet owner.

### BRIEF SUMMARY OF THE INVENTION

The design of the Pet Comfort Station enhances the care and comfort for your pet dog. The device would be self-activated as the dog walks through the station.

Various size adjustable rollers for the dog's height and width pass over the top and sides of the dog's body. The rotating rollers of the device will soothe, calm, and ultimately comfort the dog while the owner is away. The invention is adjustable in height and width to accommodate various dog sizes.

### BRIEF DESCRIPTION OF SEVERAL VIEWS OF THE DRAWINGS

FIG. 1A The top frame of the Pet Comfort Station for Dogs with its first layer of attachments to the frame.

FIG. 1B The top frame with its second layer of attachments and dimensions.

FIG. 1C The bottom frame with its first layer of attachments and dimensions.

FIG. 1D The bottom frame with its second layer of attachments and dimensions.

FIG. 1E The top and bottom frame together with their second layer of attachments.

FIG. 1F The bottom frame (side profile) with its wood blocks and caster wheels.

FIG. 2 The 6 adjustable wood pieces.

FIG. 3 The wooden blocks of the top and bottom frame and metal L-shaped brackets.

FIG. 4 The top and bottom frame, their L-shaped supporting wood corners, and wood panels.

FIG. 4A Top view of the L-shaped corner pieces of wood and cork pieces.

FIG. 4B The 4 adjustable wood pieces of the top and bottom frame for width of the device, PVC pipe holes and cork pieces.

FIG. 5 Four adjustable wood pieces with attached PVC pipes.

FIG. 6 Top and bottom frames, PVC pipes, adjustable wood pieces, PVC caps, and comfort roller brushes

FIG. 7 Magnified view of a PVC pipe with its comfort roller brushes and PVC caps.

FIG. 8 Six adjustable wood pieces; their PVC pipes and comfort roller brushes with PVC caps.

FIG. 9 The Pet Comfort Station as it appears with all its visible components.

### DETAILED DESCRIPTION OF THE INVENTION

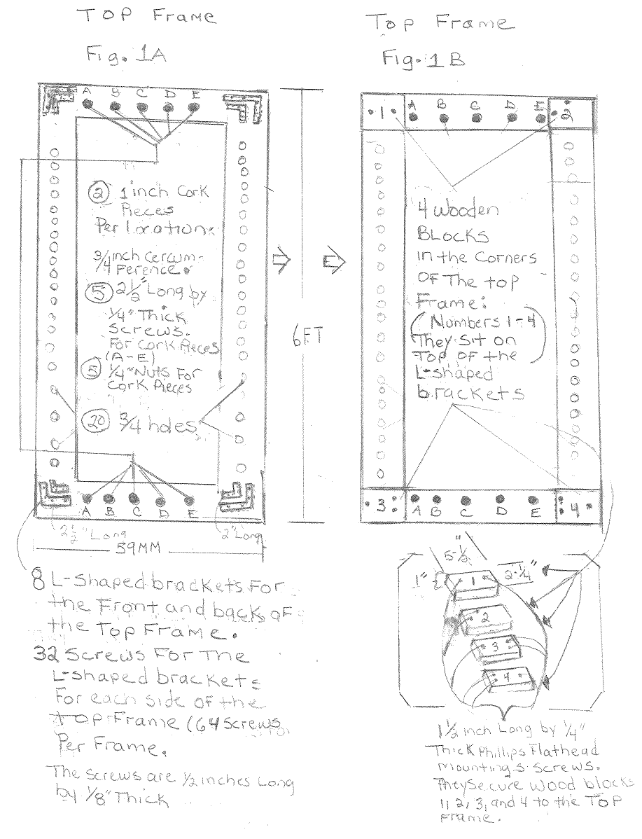

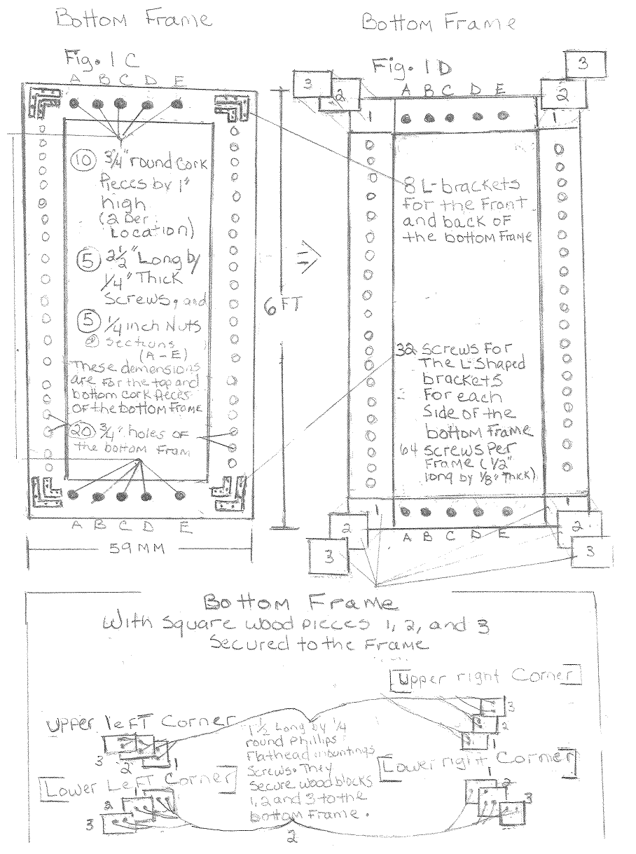

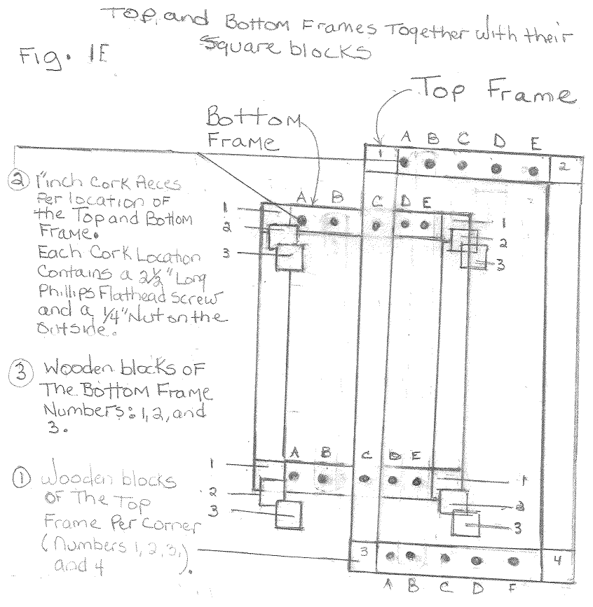

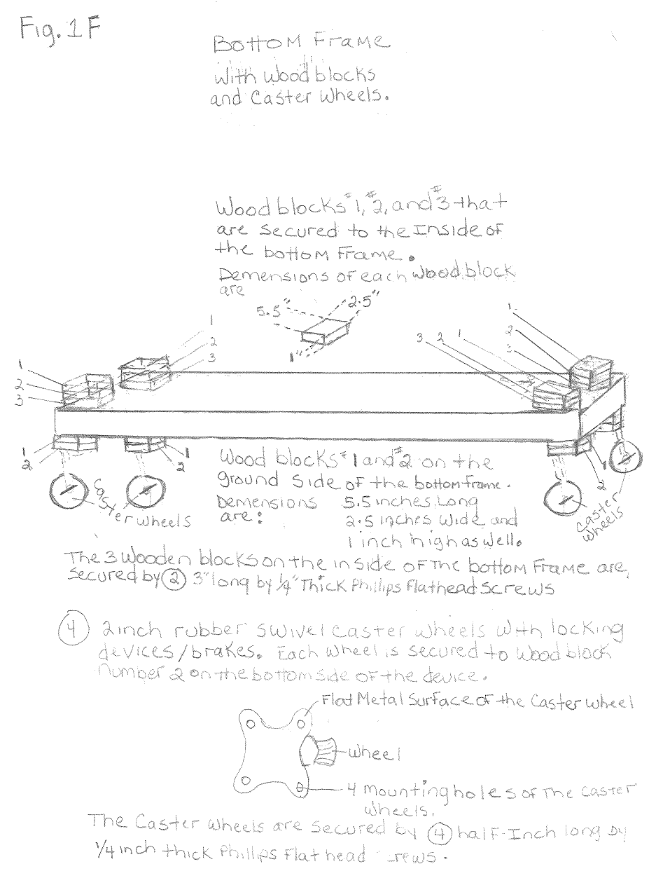

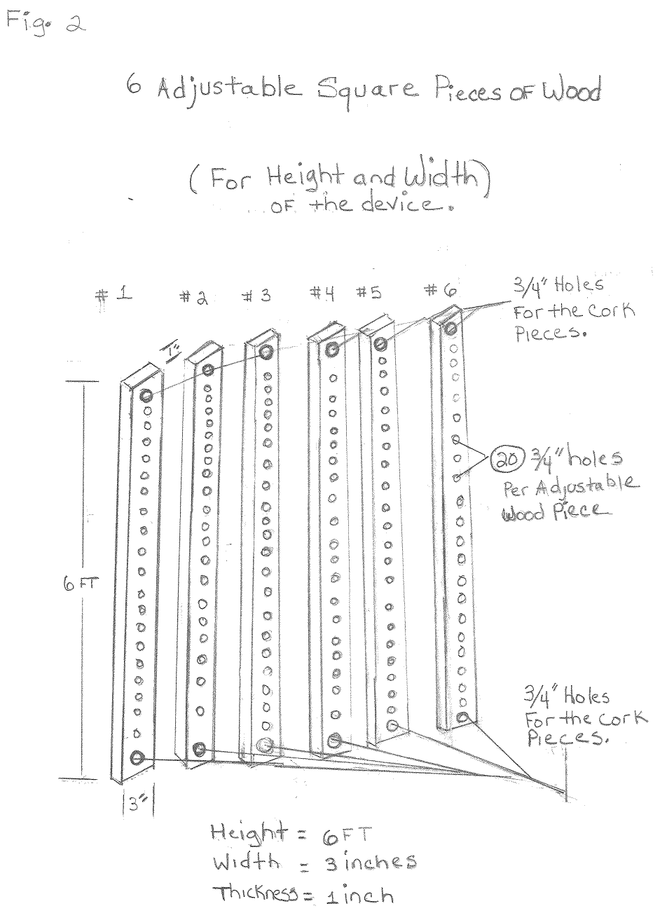

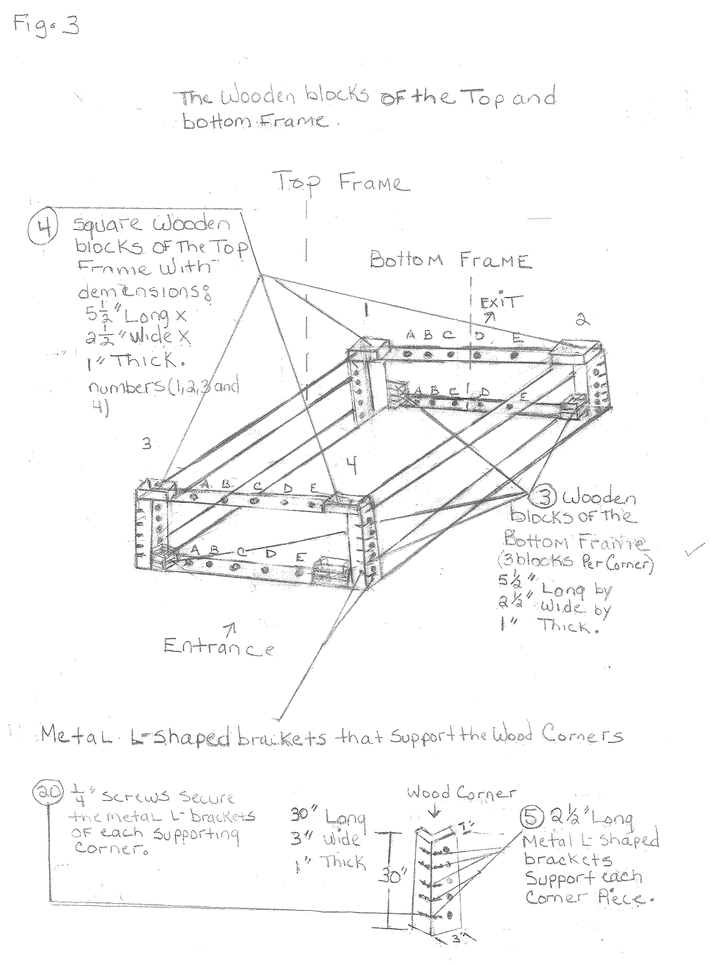

FIG. 1A Depicts the top frame of the Pet Comfort Station from an aerial view. It displays the two 1-inch-high cork pieces per location labelled A, B, C, D, and E.

Each 2-inch high cork piece is ¾ inch in circumference and has a 2½ inch long×¼ inch thick Phillips flathead screw passing through the center.

The top frame has 10 screws associated with the cork pieces total and a ¼ inch thick nut tightens the screw to the cork pieces from the top/visible side (see location A, B, C, D, and E.

It depicts the twenty ¾ inch holes of the left and right side of the top frame. It also depicts the 8 L-shaped brackets on the front and back side of the top frame.

Each corner of the top frame (the front and back side) contains one 2½ inch L-bracket and one two-inch L-bracket per corner.

It further depicts the 4 Phillips Head screws that secure each L-shaped bracket in each corner.

The screws are ½-inch long by ⅛ inch thick. Thirty-two screws secure the metal L-shaped brackets to each side of the top frame (64 screws total).

FIG. 1A Also indicates the dimensions of the wooden top frame which are 6 feet long×59 millimeters wide×1 inch thick.

FIG. 1B Represents the top frame with its 4 wooden blocks (one block per corner) of the top frame (numbers 1, 2, 3, and 4). These blocks sit on top of the metal L-shaped brackets of the top frame (the top facing side only).

Each of the wood blocks have the following dimensions: 1 inch thick×5½ inches long×2½ inches in width.

Ten 1½ inch long×¼ inch thick Phillips flathead screws secure the 4 wooden blocks to the corners of the top frame (numbers 1-4).

FIG. 1C Depicts the bottom frame of the Pet Comfort Station. It displays two one” high cork pieces per location of the bottom frame (labelled A-E).

Each cork piece is ¾ inch in circumference.

There is a 2½ inch long×¼ inch round screw that passes through each cork piece location of the bottom frame (labelled A-E).

The bottom frame contains five 2½ inch long×¼ inch thick screws at the top of the bottom frame (labelled A-E) and five 2½ inch long×¼ inch screws at the bottom of the bottom frame (labelled A-E).

It depicts the twenty ¾ inch holes of the left and right sides of the bottom frame as well.

It also indicates the 8 metal L-shaped brackets on the front and back side of the bottom frame.

Each corner of the bottom frame (front & back) contains one 2½ inch metal L-shaped bracket and one 2 inch metal L-shaped bracket per corner.

It displays the 4 screws that secure each L-shaped bracket per corner.

The screws for the L-shaped bracket are ½ inch long×⅛ inch thick.

32 screws secure the metal L-shaped brackets to the front and back side of the bottom frame (64 screws total).

The dimensions of the bottom frame are 59 millimeters wide×6 feet long×1 inch thick.

FIG. 1D Represents the front side of the bottom frame with its 3 wooden blocks in each corner of the frame (labelled 1, 2, and 3).

It also depicts the bottom frame with the screws that secure each square block to the bottom frame. There are two screws per wooden block per corner and the dimensions of the screws are: One ½ inch long×¼ inch round Phillips flathead screws.

FIG. 1E Depicts the top and bottom frames together with their square corner blocks. It shows the four square blocks of the top frame (labeled 1, 2, 3, and 4).

It also depicts the two 1 inch high×¾ inch round cork pieces per location of the top and bottom frames (labelled A,B,C, D, and E)

Each cork location contains a 2½ inch long Phillips flathead screw and a ¼ inch nut on the outside. Furthermore, it displays the three wooden blocks of the bottom frame per corner (numbers 1,2, and 3).

FIG. 1F Depicts the bottom frame with wooden blocks on both sides of the bottom frame and caster wheels with wheel locks.

Wooden blocks 1,2, and 3 are secured to the top side of the bottom frame.

The dimensions of each wooden block is 5½ inches long×2½ inches wide by 1 inch high. There are three blocks per corner and 12 blocks on the top side of the bottom frame.

The three wooden blocks on the top side of the bottom frame are secured by two 3½ inch long×¼ inch thick Phillips flathead screws.

The bottom side of the bottom frame contains two wooden blocks per corner (on the ground side) of the bottom frame. They are secured by two 3-inch-long×¼ inch thick Phillips flathead screws.

The dimensions of these blocks are 5½ inch long×2½ inches wide by 1 inch thick. There are eight wooden blocks total on the ground side of the bottom frame.

It also depicts the 4 rubber caster wheels that swivel and have locking devices/brakes. The caster wheels are secured to wooden block number 2 on the ground side of the bottom frame.

The flat metal surface of the caster wheels contain 4 mounting screw hole each. The caster wheels are secured by a 4½ inch long×¼ inch thick Phillips flathead screw.

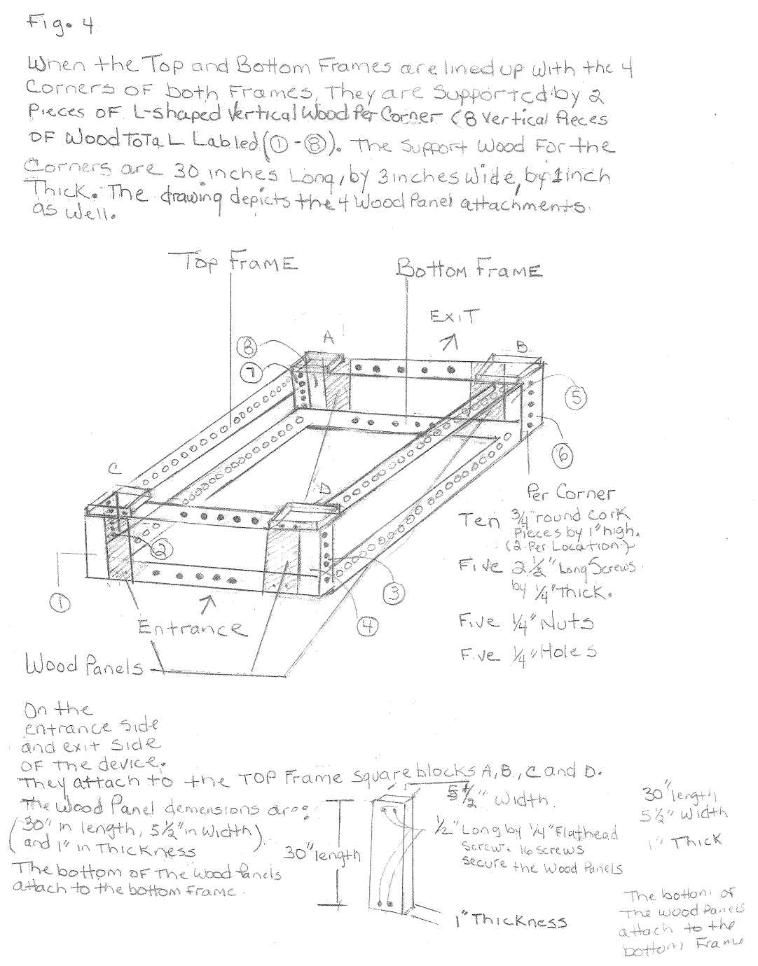

FIG. 2 Depicts the 6 adjustable wood pieces for height and width of the device. The dimensions of each adjustable wood piece are 6 feet in height, 3 inches in width, and 1 inch thick.

Each adjustable wood piece contains twenty ¾ inch holes (numbers 1-6). The last ¾ inch hole on each end of the adjustable wood pieces are for the insertion of the cork pieces of the top and bottom frames.

The adjustable wood pieces 1, 2, 3, and 4 are utilized for adjusting the width of the device and adjustable wood pieces 5 and 6 are utilized for the sides of the device. Adjustable wood piece 5 and 6 adjust the height of the top roller brushes.

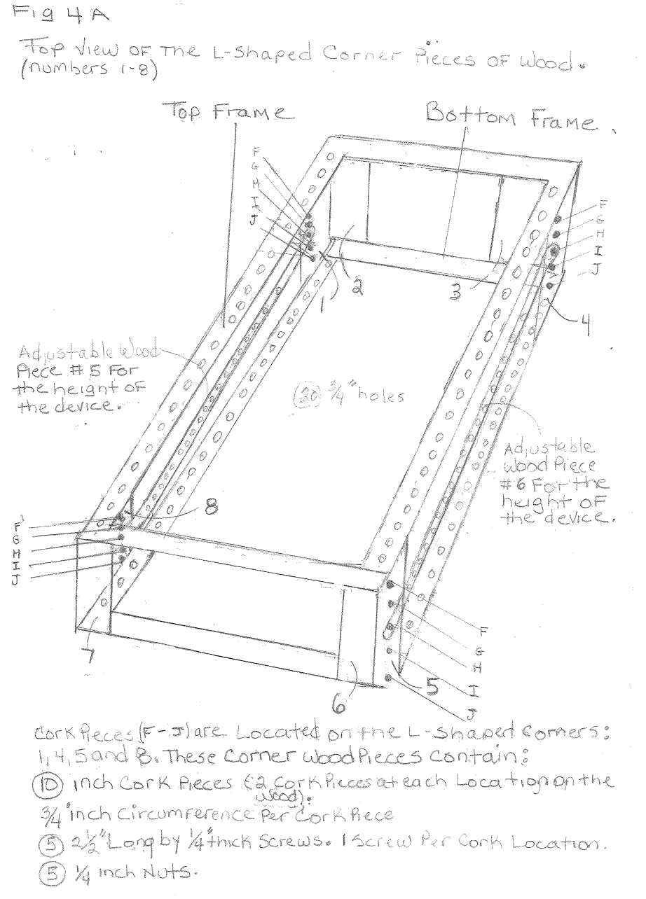

FIG. 3 Depicts the wooden blocks of the top and bottom frame with their four supporting corners.

The top frame is aligned over the bottom frame with four vertical L-shaped wooden corners.

It depicts the four square wooden blocks of the top frame with dimensions of 5½ inches long by 2½ wide by 1-inch thick (numbers 1, 2, 3, and 4).

It indicates the 3 wooden blocks of the bottom frame per corner. The dimensions are 5½ inches long by 2½ inches wide by 1 inch thick. It also displays the entrance and exit points of the device.

Furthermore, it depicts the five 2½ inch long L-shaped brackets per corner. They support the 4 vertical L-shaped wooden corners of the device.

The metal L-shaped brackets are secured with twenty ¼ inch screws per corner.

It depicts the 30-inch long by 3-inch wide by 1-inch thick vertical wooden corner. The device has 4 L-shaped wooden corners total.

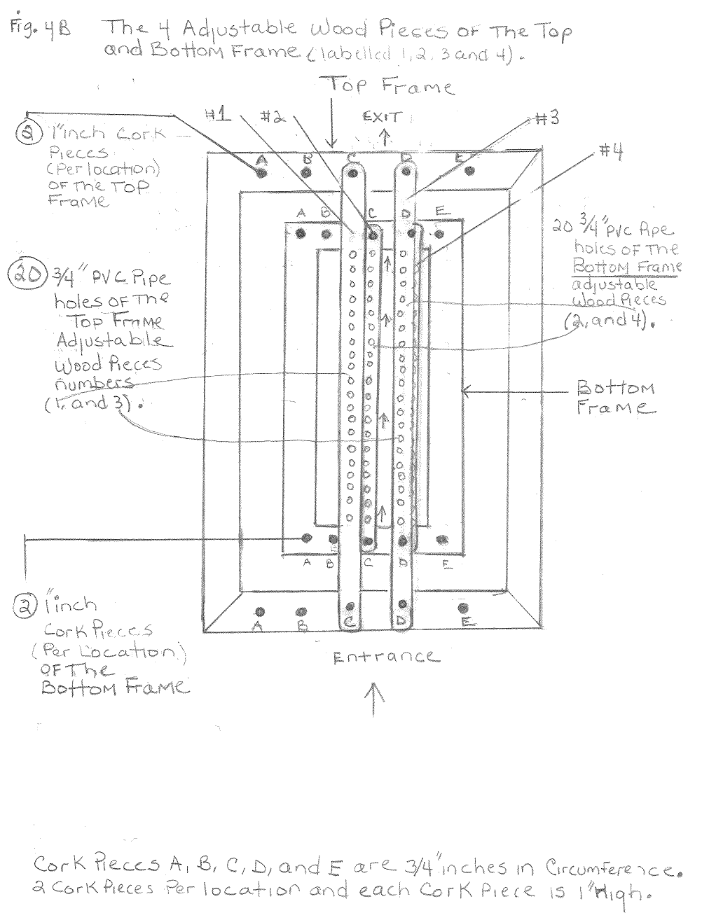

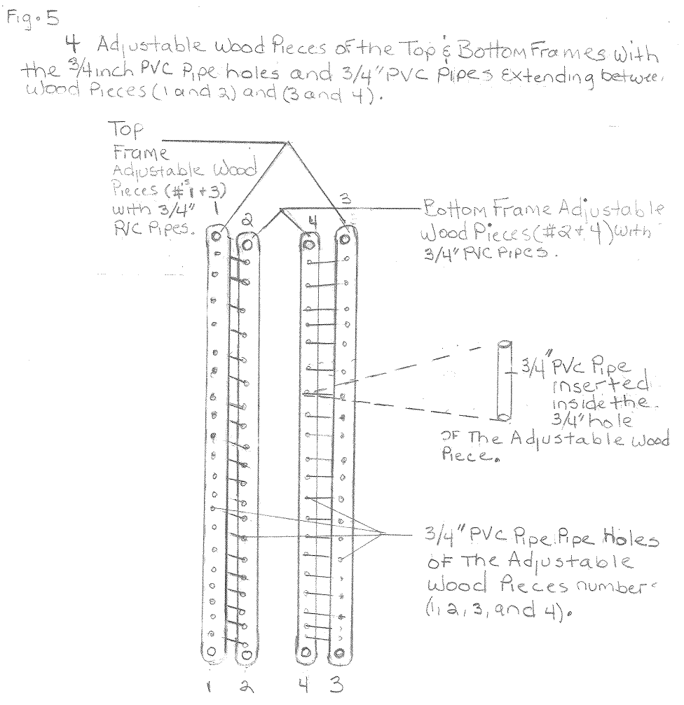

FIG. 4 Depicts the top and bottom frames supported by their two vertical L-shaped wooden pieces per corner (8 vertical pieces of wood total, labelled 1-8).

The supporting wood for the corners are 30 inches long×3 inches wide×1 inch thick.

Each vertical L-shaped wood piece (per corner) contains ten ¾ inch round cork pieces (1 inch high and 2 per location), five 2½ inch long screws×¼ inch thick, five ¼ inch nuts and five ¼ inch holes per corner.

It displays the vertical wood corners as they attach to the top frame square blocks (A, B, C, and D). It also indicates that the bottom of the vertical wood panels attached to the bottom frame per corner.

Two ½ inch long×¼ inch thick Phillips flathead screws secure the wood panels to the top frame (per corner) and two ½ inch long×¼ inch thick screws secure the wood panels to the bottom frame (per corner).

FIG. 4A Depicts a top view of the L-shaped corner pieces of wood (numbered 1-8) as they attach to the top and bottom frame.

It displays the cork pieces (F-J) located on the vertical L-shaped wooden corners (1, 4, 5, and 8). These corner pieces contain ten 1-inch cork pieces (2 cork pieces per location on the wood). The cork pieces are ¾ inches round. It also displays five 2½ inch long×¼ inch thick screws and five ¼ inch nuts that secure the cork piece to the wood.

It further depicts the 2 adjustable wood pieces, number 5 and 6 that adjust the height of the device. If both ends of adjustable wood pieces number 5 and 6 are placed on cork piece ‘letter F’ the device is at the maximum height. If both ends of adjustable wood pieces number 5 and 6 are placed at ‘letter J’, the device would be at its lowest height.

FIG. 4B Depicts the 4 adjustable wood pieces of the top and bottom frame for the width of the device. It displays the two 1-inch cork pieces (per location) of the top and bottom frame (labelled A-E).

It depicts the 4 adjustable wood pieces (numbered 1, 2, 3, and 4) for the width of the device. The figure displays the twenty ¾ inch PVC pipe holes of the top frame adjustable wood pieces, numbers 1 and 3).

Furthermore, the figure displays the twenty ¾ inch PVC pipe holes of the bottom frame adjustable wood pieces numbers 2 and 4. Cork pieces (A, B, C, D, and E) are ¾ inches in circumference, and two cork pieces exist per location. Each cork piece is 1 inch high.

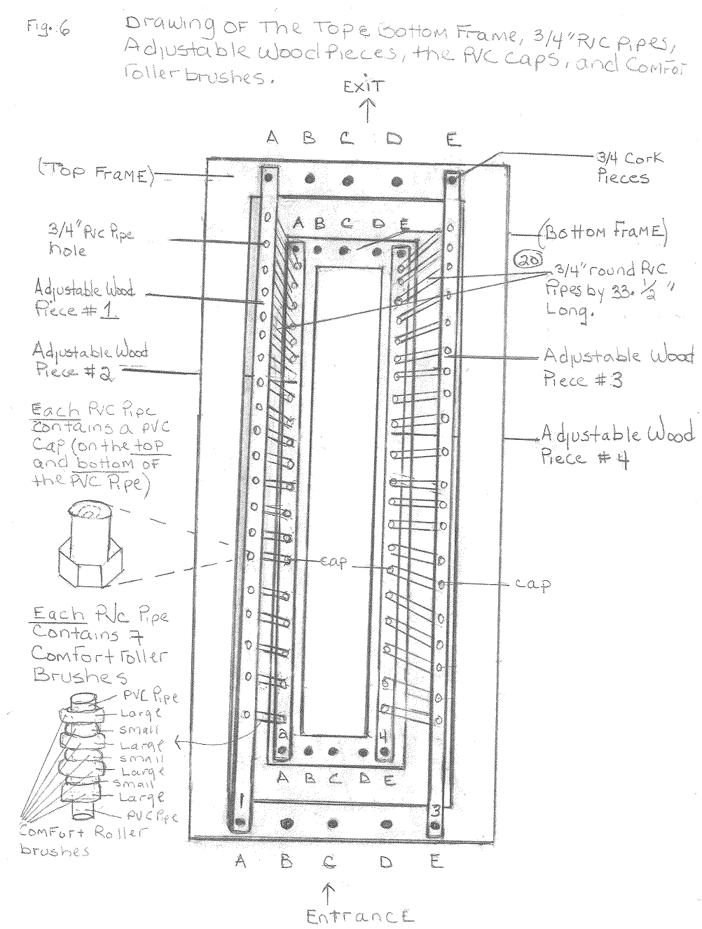

FIG. 5 Depicts the 4 adjustable wood pieces of the top and bottom frames with the ¾ inch PVC pipe extending between wood pieces (1 and 2) and (3 and 4).

FIG. 6 Depicts the top and bottom frame, the ¾ inch PVC pipes, the adjustable wood pieces, PVC caps and comfort roller brushes.

It shows the top frame with its adjustable wood pieces numbered 1 and 3 for width. It also displays the bottom frame with its adjustable wood pieces numbered 2 and 4 for width as well. The adjustable wood pieces (1,2, 3, and 4) can be moved inward toward the center to decrease the width of the device.

The frame depicts the ¾ inch PVC pipe holes, the twenty ¾ inch PVC pipes that are 33½ inches long, and insert inside each ¾ inch PVC pipe hole of the adjustable wood pieces.

Each PVC pipe contains a PVC cap on the top and bottom of the PVC pipe. The cap secures the adjustable wood pieces to the PVC pipe. FIG. 6 shows an image of the PVC cap that is attached to every PVC pipe.

It depicts the 7 comfort roller brushes per PVC pipe. The comfort roller brushes are similar to paint roller brushes. The brushes alternate between 1 large, 1 small, 1 large, 1 small, 1 large, 1 small, and 1 large comfort roller brush.

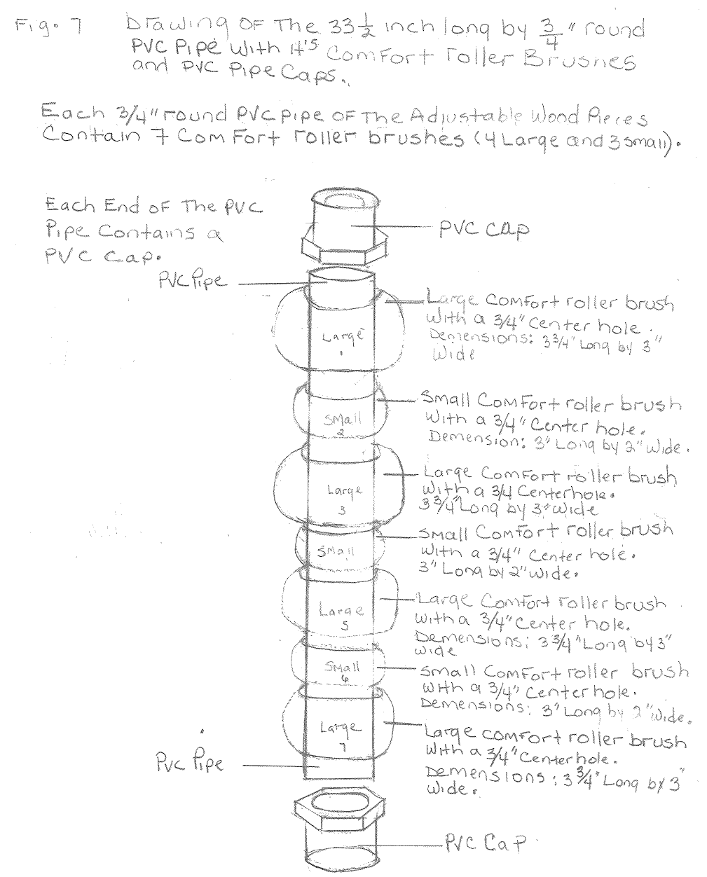

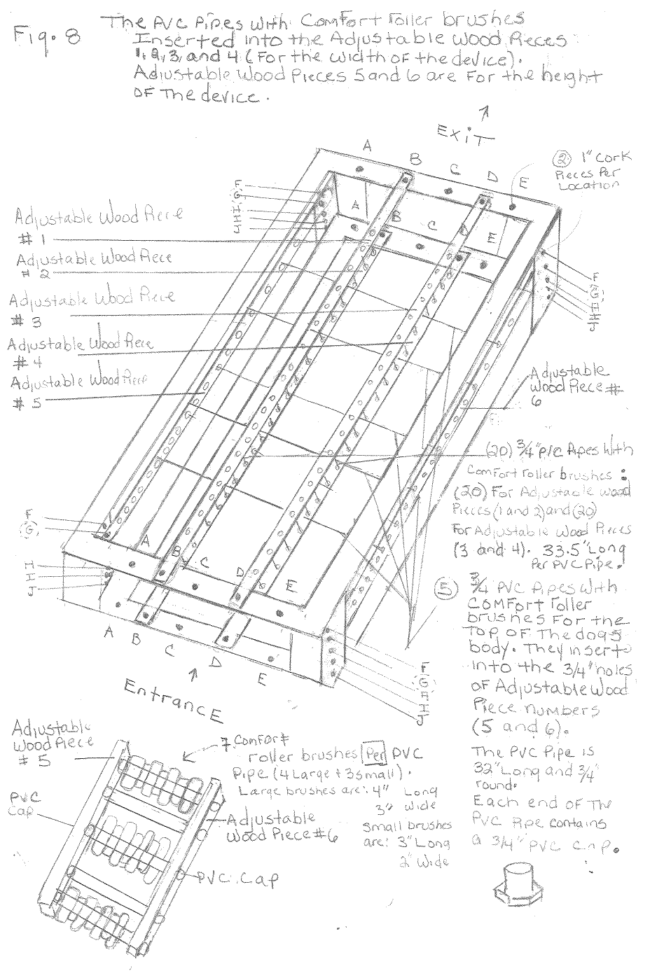

FIG. 7 Represents a magnified view of typical PVC pipe with its comfort roller brushes and caps.

It displays a PVC cap at each end of the PVC pipe. It further displays 4 large comfort roller brushes with a ¾ inch center hole. The dimensions are: 3¾ inches long×3 inches wide.

It also displays 3 small comfort roller brushes with a ¾ inch center hole and the following dimensions: 3 inches long x 2 inches wide.

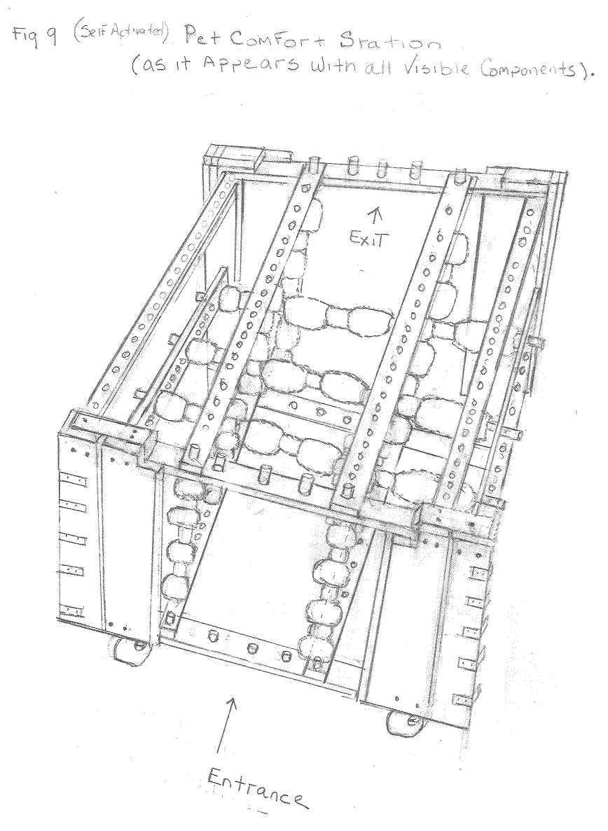

FIG. 8 Depicts the top and bottom frame with their 6 adjustable wood pieces (1, 2, 3, & 4 for the width of the device). Adjustable wood pieces 5 & 6 that make up the side of the frame are for the height of the device.

The figure further depicts the two 1-inch high by ¾ inch round cork pieces per location of the top and bottom frame labelled (A-E). Adjustable wood pieces 1 & 3 are for the top frame and adjustable wood pieces 2 & 4 are for the bottom frame.

It also depicts the 4 L-shaped vertical wood corners of the top and bottom frame with their associated cork pieces labelled (F-J). All cork pieces F-J are located inside each L-shaped vertical corner versus the outside.

Adjustable wood pieces (1 & 2) and (3 & 4) contain twenty ¾ inch round×33.5 inch long PVC pipes.

It displays adjustable wood pieces (5 & 6) with their twenty ¾ inch round holes×32 inch long PVC pipes. Each ¾ inch PVC pipe of adjustable wood pieces (1 & 2) and (3 & 4) and (5 & 6) contain 7 comfort roller brushes and two ¾ inch PVC caps (1 at each end of the pipe).

Five ¾ inch round×32 inch long PVC pipes join adjustable wood pieces 5 & 6. Each PVC pipe contains a ¾ inch PVC cap on both ends to secure the pieces to the adjustable wood pieces 5 & 6.

The 5 PVC pipes associated with adjustable wood pieces 5 & 6 also contain comfort roller brushes for the top of the dog's body.

The large comfort roller brushes are 3¾ inches long×3 inches wide. The small comfort roller brushes are 3 inches long by 2 inches wide. Both comfort roller brushes have a ¾ inch center hole.

FIG. 9 Depicts Pet Comfort Station for Dogs as it appears with all visible components.

It depicts the entrance and exit to the device. Also, the 6 adjustable wood pieces for height and width of the device.

It depicts the 4 vertical corners with their 5 metal L-brackets on the outside. It displays the placement of screws for the 4 vertical wood corners as well.

Depicts the five ¾ inch round by 1 inch high visible cork pieces of the top and bottom frame. The 4 visible blocks of the top frame corners are displayed as well.

It displays two of the four caster wheels that are attached to the bottom frame. The other 2 caster wheels are not visible due to the angle of the device (see FIG. 1F for all 4 wheels).

1. What I am claiming is an invention that will soothe, calm, massage, and comfort dogs while the owner is away for extended periods.
